(19) United States
(12) Patent Application Publication
(10) Pub. No.: US 2004/0163620 A1
(43) Pub. Date: Aug. 26, 2004

(54) Rotating piston engine

(76) Inventor: David R. Lund, East Corinth, VT (US)

Correspondence Address: B. Craig Killough, Barnwell Whaley Patterson & Helms, LLC, P.O. Drawer H, Charleston, SC, 29402, US

(21) Appl. No.: 10/781,969

(22) Filed: Feb. 19, 2004

Related U.S. Application Data
(60) Provisional application No. 60/448,742, filed on Feb. 20, 2003.
(60) Provisional application No. 60/517,790, filed on Nov. 6, 2003.

(51) Int. Cl. F02B 53/00

(52) U.S. Cl. 123/245

(57) ABSTRACT

A rotary engine is powered by pressure from gas or fluids. At least two pistons are positioned within a stator having an annular chamber. Pressure is provided between the pistons, which provides a force to push one piston relative to the other piston. One or more dogs control the travel of the pistons. Power is harvested from the pistons.

This application claims the benefit of Provisional Application Serial No. 60/448,742 filed Feb. 20, 2003, and Provisional Application Serial No. 60/517,790 filed Nov. 6, 2003.

### FIELD OF THE INVENTION

This invention relates to engines generally, and is more specifically directed to an engine having at least two pistons that travel within an annular chamber.

### BACKGROUND OF THE INVENTION

Engines have been known and used for many years. Engines convert mechanical energy or energy from a chemical source to a form of energy, which is usually rotational in nature, and which may be harvested and applied to perform work. Engines may be powered by compressed air or other gases, or by the combustion of fuel. The combustion may occur internally or externally, relative to the engine. Engines include rotary engines such as Wankel cycle engines and gas turbines, and reciprocal engines, such as Otto cycle and Diesel engines.

The advantages of rotary engines, meaning engines that do not have reciprocating pistons, are known. Rotary engines tend to have less vibration and fewer moving parts, which generally contributes to good reliability. However, internal combustion rotary engines such as Wankel engines have experienced problems with regard to rotor seals and fuel consumption. Turbine engines have been demonstrated to be extremely reliable and economical, however, manufacturing costs for these engines can be prohibitive for many applications, due to the manufacturing precision which is required and the cost of suitable materials which will withstand high temperatures.

### SUMMARY OF THE PRESENT INVENTION

The present invention is a rotary engine that is powered by pressure from gas or fluids. At least two pistons are positioned within a stator having an annular chamber. Pressure is provided between the pistons, which provides a force to push one piston relative to the other piston. One or more dogs control the travel of the pistons. Power is harvested from the pistons.

### SUMMARY OF THE DRAWING FIGURES

FIGS. 1 through 5 demonstrate an embodiment of the engine wherein gas pressure to move the pistons is supplied by internal combustion.

FIGS. 5 through 8 demonstrate an embodiment of the engine wherein pressure to move the pistons is supplied by an external source.

FIG. 9 demonstrates magnets that are attached to the pistons that generate an electrical field.

### DESCRIPTION OF THE PREFERRED EMBODIMENT

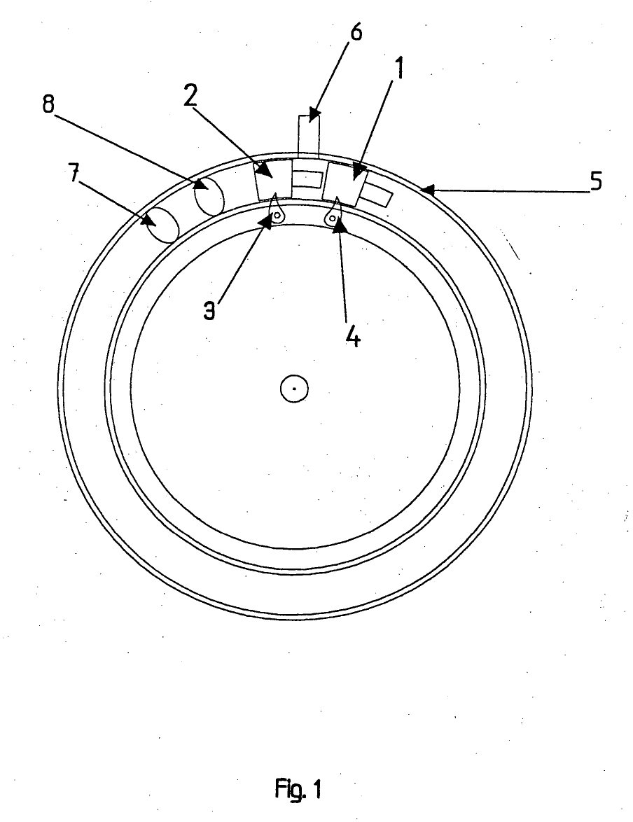

FIGS. 1 through 5 show the engine of the present invention in a dual piston embodiment, wherein the pistons 1, 2 travel in an enclosed annular chamber 5. Dogs 3, 4 limit the travel of the pistons. The device has a fuel inlet 8, and an exhaust 7. An igniter 6 extends into the combustion chamber.

Turning specifically to FIG. 1, piston 1 and piston 2 are shown in close relationship within the annular chamber, with the pistons abutting, or substantially abutting each other. Each piston is formed to contact the walls of the annular chamber. The annular chamber is circular in the preferred embodiment. Accordingly, the pistons are formed to provide a seal between the wall of the chamber and the pistons, while travel of the pistons within the chamber is facilitated. Each piston has a protrusion extending from one side of the piston. The protrusion maintains a space between the main body of each piston, such as when the pistons are in the position shown as FIG. 1. Further, a sub-chamber is created between the pistons when they are shown in relative position of FIG. 1, with the bodies of the pistons on each side, and the walls of the annular chamber, forming the sub chamber. The sub chamber is the resulting space formed within the annular chamber and between the pistons. Since the protrusion of the piston 2 is smaller than the body of piston 2 and the body of piston 1, an area is present between the bodies of the pistons that forms the sub chamber.

When the pistons are positioned as shown in FIG. 1, a fuel air mixture is present in the space or sub-chamber that is present between piston 1 and piston 2. This sub-chamber is demonstrated by the space that is underneath the igniter 6. The movement of piston 2 to a position that is relatively close to piston 1 compresses the fuel air mixture. Piston 1 is held in place by dog 4, so that as piston 2 moves toward piston 1, piston 1 is stationary, and the fuel air mixture that is between piston 1 and piston 2 is compressed.

Igniter 6 ignites the fuel air mixture after it is compressed within the sub-chamber by the pistons. Dog 4 momentarily holds piston 1 in place after ignition, and it then releases piston 1. Dog 4 is externally actuated, such as by mechanical or electrical controls that are timed to the position of the pistons and/or the timing of the igniter. The timing of the igniter is controlled by electrical or electromechanical means based upon the position of the pistons.

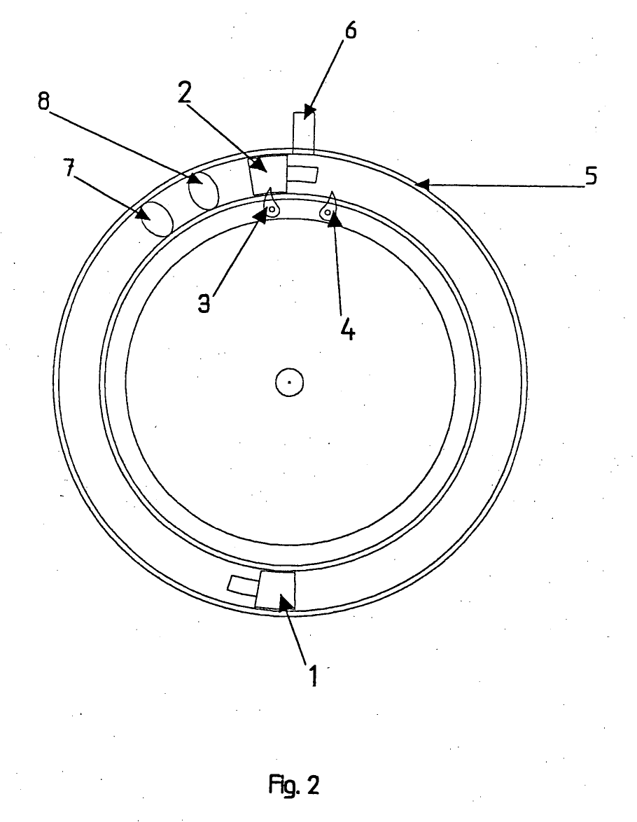

Turning now to FIG. 2, the force from combustion of the fuel-air mixture pushes piston 1 in a clockwise direction, and away from piston 2. Piston 2 is held in place by dog 3, so that it is not pushed in a counter-clockwise direction by the force of combustion.

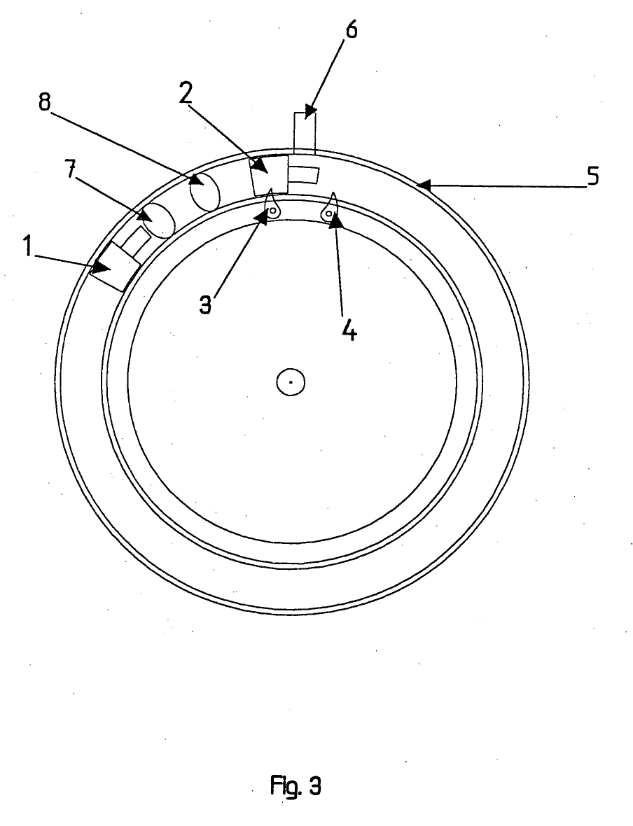

Piston 1 continues to travel in a clockwise direction as shown in FIG. 3. As piston 1 approaches exhaust port 7, it is still being propelled by pressure from the combustion of the fuel air mixture.

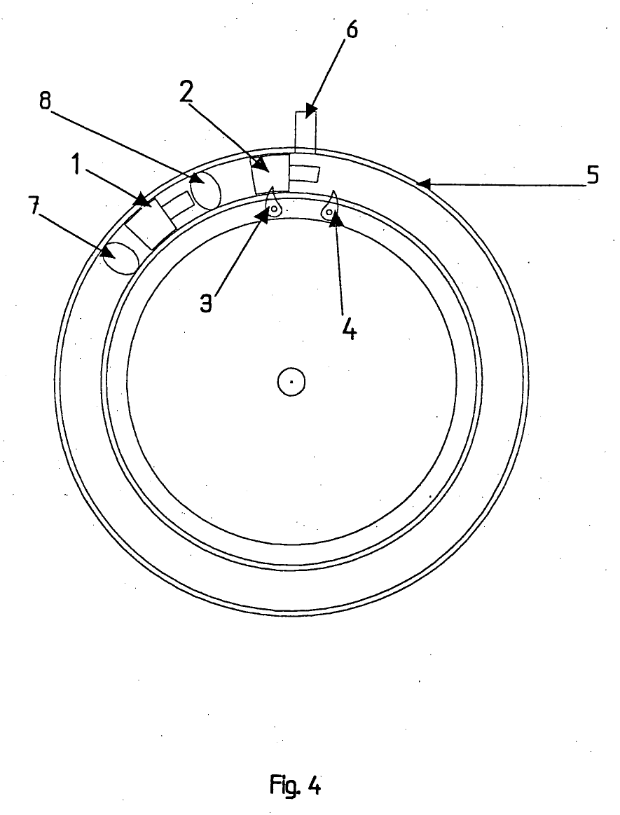

Piston 1 passes exhaust port 7 as shown in FIG. 4, whereupon the pressure from combustion is released through the exhaust port. Due to momentum, piston 1 will continue to travel clockwise within the circular combustion chamber. As piston 1 approaches inlet 8, a fuel air mixture is released or injected into the circular chamber. FIG. 4.

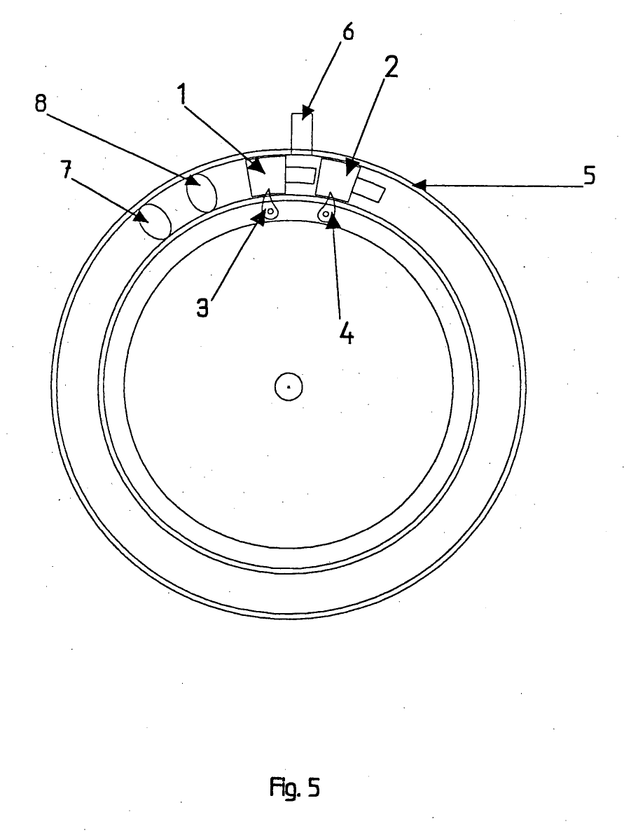

In FIG. 5, the pistons are in the same relative position as in FIG. 1, excepting that piston 1 and piston 2 have changed places. As piston 1 moves from the position of FIG. 4 to the position of FIG. 5, it bumps piston 2. Dog 3 is constructed so that it allows the pistons to travel in a clockwise direction as shown in the drawing figures, but will not permit the pistons to travel in a counterclockwise direction. Accordingly, as piston 1 contacts or bumps piston 2, it pushes piston 2 against dog 4. The travel of piston 1 is also stopped as the protrusion contacts piston 2, so that dog 4 holds both pistons. Neither piston can travel in a clockwise position due to dog 4, and piston 1 cannot travel in a counterclockwise direction because it is now being held by dog 3. The fuel air mixture is compressed between piston 1 and piston 2 as shown in FIG. 5. The fuel air mixture is then ignited and momentarily thereafter, dog 4 releases piston 2, which travels in a clockwise position, while piston 1 is held in place by dog 3. This cycle is repeated, thereby operating the dual piston internal combustion embodiment of the invention.

As shown in he drawings, the dogs pivot relative to the annular chamber as they alternately hold and release the pistons. The dogs pivot in opposite directions due to the force that is transferred to them by the pistons, which results from ignition of the fuel in the sub chamber, and between the pistons Other means for selectively timing and holding the pistons could be employed.

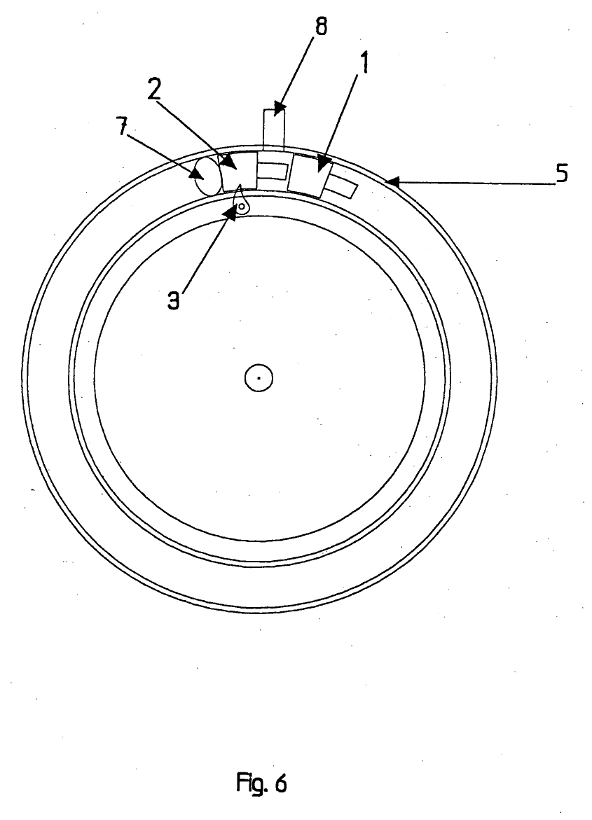

FIGS. 6-8 show the engine of the present invention in a dual piston embodiment, wherein the pistons 1, 2 travel in an enclosed annular chamber 5. Dog 3 limits the travel of the pistons. The device has a fuel or pressure inlet 8 and an exhaust 7. This embodiment of the device is powered by pressurized gas, such as steam or externally combusted fuels, or pressurized liquids, such as pressurized water or other hydraulic pressure, any of which may be used as the fuel for the device.

As with the previous embodiment, the device has a circular and annular chamber 5. The pistons are formed so as to travel within the chamber, and provide a seal between the pistons and the walls of the chamber. A protrusion extends from one end of each of the pistons, and the same end for each piston. The protrusion provides spacing for the pistons, while also allowing a sub-chamber to be formed between the pistons and within chamber 5.

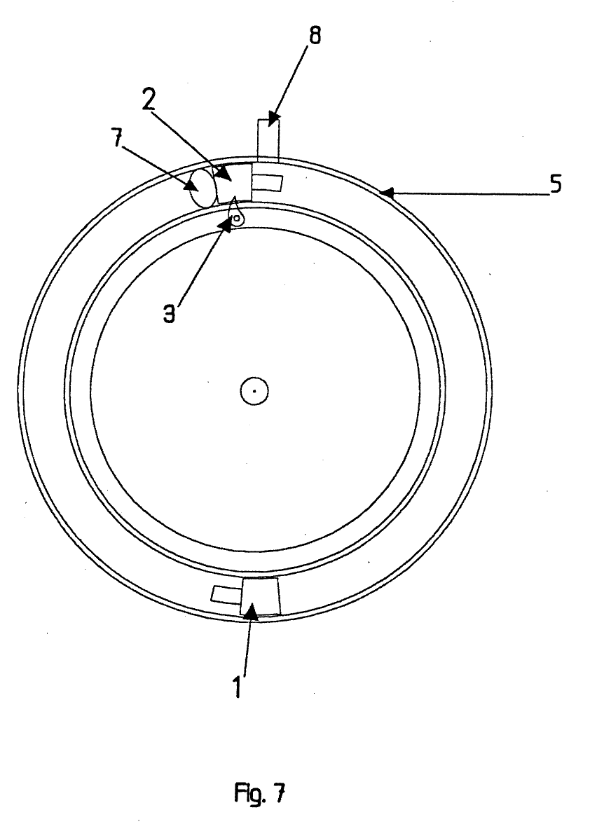

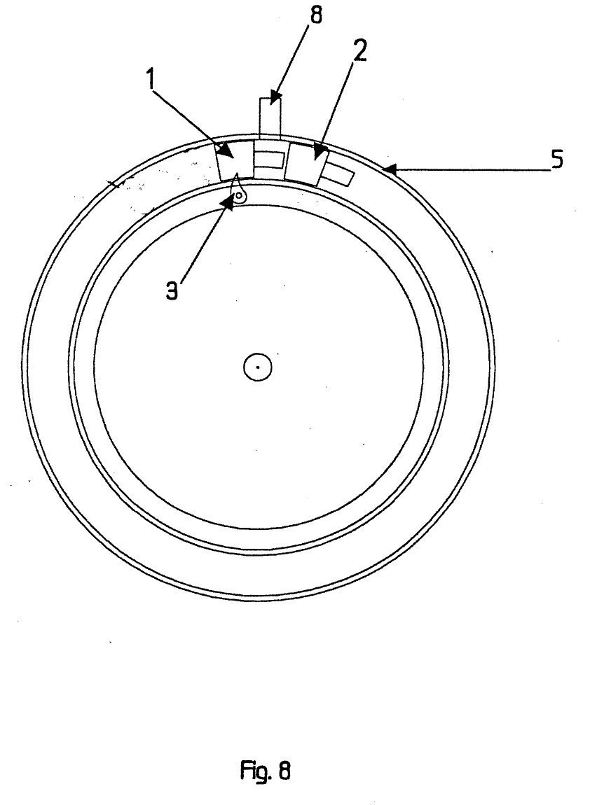

Turning now to FIG. 6, pistons 1 and 2 are in a close relationship within the chamber. A sub-chamber is present between piston 1 and piston 2, which is shown as being underneath inlet 8 in FIG. 6. A pressurized medium, which may be a gas or liquid, enters chamber 5 through inlet 8 and between piston 1 and piston 2. Piston 2 is held in place by dog 3, which limits the counterclockwise rotation of piston 2. The pressurized medium forces FIG. 1 in a clockwise direction. FIG. 7. Piston 1 continues to travel in a clockwise direction within the chamber until it reaches the position shown in FIG. 8. As it reaches the position shown in FIG. 8, pressure behind piston 1 is released through outlet 7. The pressurized medium, which continuously enters inlet 8, retards piston 1 from traveling to inlet 8. However, the pressure from inlet 8 does not cause piston 1 to materially rotate counterclockwise, because dog 3 holds piston 1, and prevents piston 1 from being pushed in a counterclockwise direction by the pressurized medium entering through inlet 8. However, piston 1 has pushed piston 2 in a clockwise direction, as piston 1 takes the position between outlet 7 and inlet 8. Piston 2 is now subject to the force of the pressurized medium entering through inlet 8, and piston 2 is forced in a clockwise direction. Piston 2 will travel around the circular chamber 5, being pushed by the pressurized medium, until piston 2 passes exhaust outlet 7, whereupon it is no longer subject to the pressurized medium behind it, and whereupon the clockwise momentum of piston 2 is retarded by the pressurized medium entering the chamber through inlet 8. Piston 2 cycles to force piston 1 away, so that piston 1 is again in the position of FIG. 6, and the cycle is repeated.

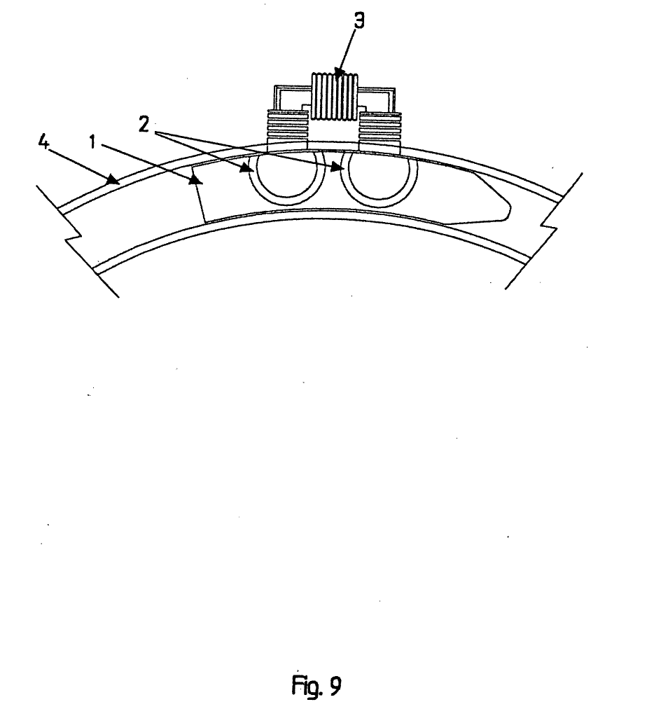

FIG. 9 demonstrates how energy may be harvested from the engine of the present invention. Piston 1 is shown as having magnets located on the pistons. The magnets generate an electrical field as they pass through electrical generators, thereby creating electricity. Multiple generators are positioned around the stator, and adjacent to the chamber, for harvesting the power. As the pistons continue to rotate due to the repeated cycles of the engine, electricity is generated.

What is claimed is:

1. A rotary engine, comprising:
a stator having an annular chamber therein;
a first piston that is disposed within said annular chamber, wherein said first piston traverses said chamber;
a second piston that is disposed within said annular chamber, wherein said second piston traverses said annular chamber;
at least one dog that is positioned within said annular chamber and which selectively limits the directional travel of said first piston and said second piston;
at least one fuel inlet to said annular chamber; and
at least one exhaust outlet from said annular chamber.

2. A rotary engine as described in claim 1, wherein said first piston comprises a body and a protrusion extending from a side of said body of said first piston, and wherein said second piston comprises a body and a protrusion extending from a side of said body of said second piston, and wherein a subchamber is formed when said first piston and said second piston substantially abut each other, and wherein one end of said subchamber is closed by said body of said first piston and an opposite end of said subchamber is closed by said body of said second piston, and the remainder of said sub chamber is closed by walls of said annular chamber.

3. A rotary engine as described in claim 1 comprising a first dog and a second dog, wherein said first dog selectively limits travel of one of said first piston and said second piston in one direction, while said second dog selectively limits travel of a remaining one of said first piston and said second piston in an opposite direction.

4. A rotary engine as described in claim 2 comprising a first dog and a second dog, wherein said first dog selectively limits travel of one of said first piston and said second piston in one direction, while said second dog selectively limits travel of a remaining one of said first piston and said second piston in an opposite direction.

5. A rotary engine as described in claim 1, wherein said annular chamber is generally circular.

6. A rotary engine as described in claim 1, wherein said annular chamber has a generally circular cross section.

7. A rotary engine as described in claim 4, wherein said sub chamber is present between said first piston and said second piston when travel of said first piston and said second piston are stopped by said first dog and said second dog.

8. A rotary engine as described in claim 7, wherein an igniter communicates with said chamber and said sub chamber.

9. A rotary engine as described in claim 3, wherein when said first dog limits and stops the travel of one of said first piston and said second piston in one direction, the travel of a remaining of said first piston and said second piston forces said one of said first piston and said second piston forward, wherein movement of said one of said first piston and said second piston is stopped by said second dog.

10. A rotary engine as described in claim 9, wherein the travel of said remaining of said first piston and said second piston is stopped by said first dog after said remaining of said first piston and said second piston is forced forward.

11. A rotary engine as described in claim 9, wherein fuel is received between said first piston and said second piston while one of said first, piston and said second piston in stopped and said remaining of said first piston and said second piston travels.
